(19) United States
(12) Patent Application Publication
(10) Pub. No.: US 2010/0333015 A1
(43) Pub. Date: Dec. 30, 2010

(54) METHOD AND APPARATUS FOR REPRESENTING TEXT INFORMATION

(75) Inventors: Peter Dam Nielsen, Kgs Lyngby (DK); Christian Rossing Kraft, Frederiksberg C. (DK)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/494,488

(22) Filed: Jun. 30, 2009

(51) Int. Cl. G06F 3/048

(52) U.S. Cl. 715/784

(57) ABSTRACT

An apparatus is provided that includes a processor and memory including computer program code, the memory and the computer program code configured to, working with the processor, cause the apparatus to perform at least the following: provide for receiving text information, provide for representing at least part of received text information in an edit region, determine that less than all received text information is represented in said edit region, determine at least part of said received text information to scroll, and cause scrolling of said determined text information in at least one scrolling region is disclosed. A corresponding method and computer readable medium are also disclosed.

### TECHNICAL FIELD

The present application relates generally to representing text information.

### BACKGROUND

There has been a recent surge in the use of electronic devices. Some of these devices allow a user to perform operations on text information. For example, a user may view text information, edit text information, copy text information, delete text information, select text information, and/or the like.

### SUMMARY

Various aspects of examples of the invention are set out in the claims.

According to a first aspect of the invention, an apparatus, comprising a processor and memory including computer program code, the memory and the computer program code configured to, working with the processor, cause the apparatus to perform at least the following: provide for receiving text information, provide for representing at least part of received text information in an edit region, determine that less than all received text information is represented in said edit region, determine at least part of said received text information to scroll, and cause scrolling of said determined text information in at least one scrolling region is disclosed.

According to a second aspect of the invention, a method comprising receiving text information, representing at least part of received text information in an edit region, determining that less than all received text information is represented in said edit region, determining at least part of said received text information to scroll, and causing scrolling of said determined text information in at least one scrolling region is disclosed.

According to a third aspect of the invention, a computer-readable medium encoded with instructions that, when executed by a computer, perform providing for receiving text information, providing for representing at least part of received text information in an edit region, determining that less than all received text information is represented in said edit region, determining at least part of said received text information to scroll, and causing scrolling of said determined text information in at least one scrolling region is disclosed.

According to a fourth aspect of the invention, a computer program product comprising a computer-readable medium bearing computer program code embodied therein for use with a computer, the computer program code comprising code for providing for receiving text information, code for providing for representing at least part of received text information in an edit region, code for determining that less than all received text information is represented in said edit region, code for determining at least part of said received text information to scroll, and code for causing scrolling of said determined text information in at least one scrolling region is disclosed.

### BRIEF DESCRIPTION OF THE DRAWINGS

For a more complete understanding of example embodiments of the invention, reference is made to the following descriptions taken in connection with the accompanying drawings in which:

FIGS. 1A-1H are diagrams illustrating a text information representation;

FIG. 2 is a flow diagram showing a set of operations for representing text information;

FIG. 3 is a flow diagram showing another set of operations for representing text information;

FIG. 4 is a flow diagram showing still another set of operations for representing text information; and

FIG. 5 is a block diagram showing an apparatus according to an example embodiment of the invention.

### DETAILED DESCRIPTION OF THE DRAWINGS

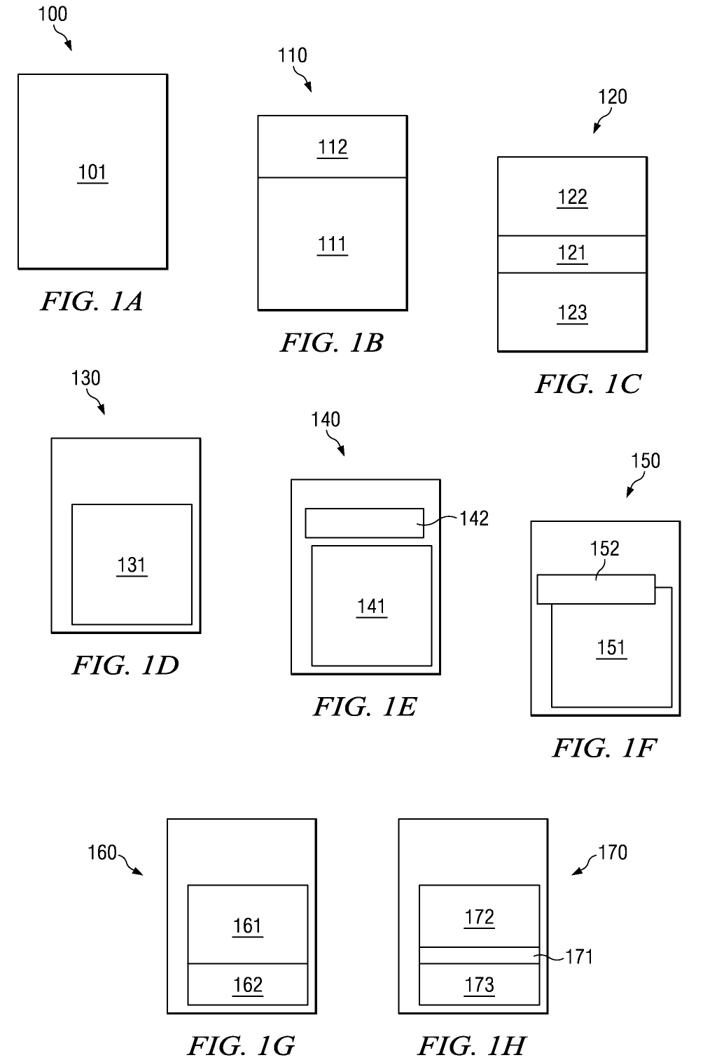

An example embodiment of the invention and its potential advantages are understood by referring to FIGS. 1 through 5 of the drawings.

In an example embodiment, a user views text information on an apparatus. The text information may comprise at least one character, such as a letter, a symbol, a number, a space, a control character, a punctuation character, and/or the like. The apparatus may represent text information in one or more rows, columns, and/or the like. The arrangement of the text information represented may vary. For example, the apparatus may represent text information in one or more rows. In such an example, the apparatus may represent the text information progressively from left to right within a row, and from top to bottom across rows. In another example, the apparatus may represent text information in one or more columns. In such an example, the apparatus may represent the text information progressively from top to bottom in a column, and from right to left across columns.

In an example embodiment, a user may view text information represented in an edit region. An edit region may comprise one or more rows and/or columns of text information. An edit region may represent at least part of text information. For example, an edit region may represent text information in its entirety. In another example, an edit region may represent a part of text information that is less than the entirety of the text information. In an example embodiment, a user may perform an operation on the represented text information of the edit region such as selecting, modifying, adding, removing, and/or the like. In such an embodiment, the operation performed on the representation of text information in the edit region may cause performing operations on the text information, itself. For example, a user may add characters to a text information representation of an edit region. In another example, a user may remove characters from a text information representation of an edit region.

In an example embodiment, a user may utilize an edit region for editing text information associated with a document, message, email, webpage, image, and/or the like. For example, a user may utilize an edit region when editing a body of an email, text message, instant message, and/or the like. In another example, a user may utilize an edit region when editing a document such as a report, electronic book, and/or the like.

In an example embodiment, a user may desire to view text information that is not represented in the edit region. For example, a user may forget whether he has included an address in the text information. In such an example, the user may desire to view part of the text information that may contain the address. In another example, the user may forget whether he spelled a name correctly in a part of the text information not represented in the edit region. In such an example, the user may desire to view a part of the text information that comprises the name.

In an example embodiment, a user may benefit from an apparatus scrolling a representation of the text information when the apparatus represents less than all of the text information in the edit region. Scrolling may relate to an apparatus automatically progressively representing text information to a user. For example, scrolling may relate to the representation of text information appearing to move horizontally, vertically, and/or the like. The scrolling may provide a representation of the text information that varies, over time, the part of the text information represented. In an example embodiment, the apparatus may represent the scrolling of the text information in a scrolling region. The scrolling region may comprise one or more rows, columns, pages, and/or the like, of text information. For example, the scrolling region may comprise one or more rows of text scrolling horizontally. In another example, the scrolling region may comprise one or more rows of text scrolling vertically. In still another example embodiment, the scrolling region may comprise one or more columns of text scrolling vertically. In yet another example, the scrolling region may comprise one or more columns of text scrolling horizontally. In a further example, the scrolling region may comprise a plurality of rows and columns of text scrolling by page in ascending page order.

In an example embodiment, the apparatus may scroll text information in a scrolling region associated with text information represented in an edit region. For example, the apparatus may scroll text information positioned prior to the part of text information represented in the edit region. In such an embodiment, a technical effect is that the apparatus does not receive input from the user to cause the apparatus to represent a different part of the text information in the edit region, thereby conserving processing resources that may otherwise be expended to respond to user requests to scroll the text information. For example, if the apparatus is causing display of the text information on a small display, the user may utilize the scrolling text information to view text information not represented in the edit region, and avoid changing the part of the text information represented in the edit region. In such an embodiment, another technical effect is the apparatus performing editing in less time by allowing the user to view a part of the text information not represented in the edit region without the user causing the apparatus to represent a different part of the text information in the edit region, thereby conserving the processing resources that may otherwise be expended to alternately view the different parts of the text information.

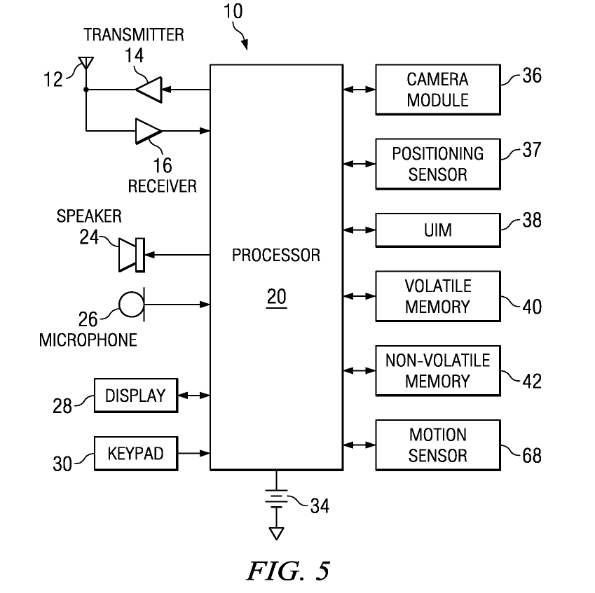

FIGS. 1A-1H are diagrams illustrating a text information representation. The examples of FIGS. 1A-1H are merely examples of text information representation and do not limit the invention. For example, different embodiments may vary in size, orientation, number of elements, position of elements, and/or the like. Even though the examples of FIGS. 1A-1H illustrate text information representation based on rows, other embodiments may represent text information based on columns, for example to represent Chinese text information, Japanese text information, and/or the like. An apparatus, for example electronic device 10 of FIG. 5, may cause the text information representation of one or more of FIGS. 1A-1H to be displayed, for example using display 28 of FIG. 5, an external display, a display associated with a different electronic device, and/or the like. The text information representations of FIGS. 1A-1H may relate to a display, a window, a frame, and/or the like. For example, a text information representation may be associated with a display, such as display 28 of FIG. 5. In another example, a text information representation may be associated with a window that is caused to be displayed on a display, such as display 28 of FIG. 5. Even though the examples of FIGS. 1A-1H illustrate a single edit region, a text information representation may comprise more than one edit region.

FIG. 1A is a diagram illustrating a text information representation 100 comprising an edit region 101. In the example of FIG. 1A, the text information may consist entirely of edit region 101.

FIG. 1B is a diagram illustrating a text information representation 110 comprising an edit region 111 and scrolling region 112. In the example of FIG. 1B, the text information may consist entirely of edit region 111 and scrolling region 112. Even though the example of FIG. 1B illustrates scrolling region 112 above edit region 111, the relative position of scrolling region 112 and edit region 111 does not limit the scope of the invention. In an example embodiment edit region 111 and scrolling region 112 may overlap. For example, scrolling region 112 may overlay, cover, obscure, and/or the like, edit region 111. In another example, edit region 111 may overlay, cover, obscure, and/or the like, scrolling region 112. In addition to the relative physical positions of the scrolling region 112 and the edit region 111, the text information represented within the scrolling region and the edit region may have various relationships. For example, the text information represented within the scrolling region may precede the text information represented within the edit region, may follow the text information represented within the edit region, may overlap the text information represented within the edit region, and/or the like. The relationship may depend, for example, upon the configuration of the electronic device and/or user input.

FIG. 1C is a diagram illustrating a text information representation 120 comprising an edit region 121, scrolling region 122, and scrolling region 123. In the example of FIG. 1C, the text information may consist entirely of edit region 121, scrolling region 122, and scrolling region 123. Even though the example of FIG. 1C illustrates scrolling region 122 above edit region 121 and scrolling region 123 below edit region 121, the relative position of scrolling region 122, scrolling region 123, and edit region 121 does not limit the scope of the invention. In an example embodiment edit region 121, scrolling region 122, and/or scrolling region 123 may overlap. For example, scrolling region 122 may overlay, cover, obscure, and/or the like, edit region 121 and/or scrolling region 123. In another example, edit region 121 may overlay, cover, obscure, and/or the like, scrolling region 122 and/or scrolling region 123. In addition to the relative physical positions of the scrolling region 122 and the edit region 121, the text information represented within the scrolling region and the edit region may have various relationships. For example, the text information represented within the scrolling region may precede the text information represented within the edit region, may follow the text information represented within the edit region, may overlap the text information represented within the edit region, and/or the like. The relationship may depend, for example, upon the configuration of the electronic device and/or user input.

FIG. 1D is a diagram illustrating a text information representation 130 comprising an edit region 131. In the example of FIG. 1D, text information representation 130 may comprise information in addition to edit region 131. For example, text information representation may comprise one or more graphical elements, different text information, control information, and or the like. A graphical element may relate to a border, a logo, an image, a design, and/or the like. Different text information may relate to title information, subject information, address information, messaging information, and/or the like. Control information may relate to a menu, a program operation, a user interface element, and/or the like. In addition to the relative positions of the scrolling region 132 and the edit region 131, the text information represented within the scrolling region and the edit region may have various relationships. For example, the text information represented within the scrolling region may precede the text information represented within the edit region, may follow the text information represented within the edit region, may overlap the text information represented within the edit region, and/or the like. The relationship may depend, for example, upon the configuration of the electronic device and/or user input.

In an example embodiment, text information representation may relate to a text message. In such an embodiment, text information representation 130 may comprise address information associated with a recipient, sender, and/or the like. In such an embodiment, text information representation may comprise a subject of the message, which may be represented in an additional edit region. In such an embodiment, text information representation 130 may comprise control information associated with sending the message, saving the message, and/or the like.

FIG. 1E is a diagram illustrating a text information representation 140 comprising an edit region 141 and scrolling region 142. Even though the example of FIG. I E illustrates scrolling region 142 above edit region 141, the relative position of scrolling region 142 and edit region 141 does not limit the scope of the invention. In the example of FIG. 1E, text information representation 140 may comprise information in addition to edit region 141 and scrolling region 142 similarly as described with reference to FIG. 1D. In the example of FIG. 1E, the edit region and scrolling region are positioned non-adjacently in the text information representation. In addition to the relative positions of the scrolling region 142 and the edit region 141, the text information represented within the scrolling region and the edit region may have various relationships. For example, the text information represented within the scrolling region may precede the text information represented within the edit region, may follow the text information represented within the edit region, and/or the like. The relationship may depend, for example, upon the configuration of the electronic device and/or user input.

FIG. 1F is a diagram illustrating a text information representation 150 comprising an edit region 151 and scrolling region 152. Even though the example of FIG. 1F illustrates scrolling region 152 relative to the top of edit region 151, the relative position of scrolling region 152 and edit region 151 does not limit the scope of the invention. In an example embodiment edit region 151 and scrolling region 152 may overlap. For example, scrolling region 152 may overlay, cover, obscures and/or the like, edit region 151. In the example of FIG. 1F, text information representation 150 may comprise information in addition to edit region 151 and scrolling region 152 similarly as described with reference to FIG. 1D. In the example of FIG. 1F, the scrolling region partially overlaps the edit region such that at least part of the edit region relates to a position outside of the scrolling region and at least part of the scrolling region relates to a position outside of the edit region. In addition to the relative positions of the scrolling region 152 and the edit region 151, the text information represented within the scrolling region and the edit region may have various relationships. For example, the text information represented within the scrolling region may precede a part of the text information represented within the edit region, may follow a part of the text information represented within the edit region, and/or the like. The relationship may depend, for example, upon the configuration of the electronic device and/or user input.

FIG. 1G is a diagram illustrating a text information representation 160 comprising an edit region 161 and scrolling region 162. Even though the example of FIG. 1G illustrates scrolling region 162 below edit region 161, the relative position of scrolling region 162 and edit region 161 does not limit the scope of the invention. In an example embodiment edit region 161 and scrolling region 162 may overlap. For example, scrolling region 162 may overlay, cover, obscure, and/or the like, edit region 161. In the example of FIG. 1G, text information representation 160 may comprise information in addition to edit region 161 and scrolling region 162 similarly as described with reference to FIG. 1D. In the example of FIG. 1G, the scrolling region partially overlaps the edit region such that at least part of the edit region relates to a position outside of the scrolling region and at the entirety of the scrolling region relates to a position within the edit region. In addition to the relative positions of the scrolling region 162 and the edit region 161, the text information represented within the scrolling region and the edit region may have various relationships. For example, the text information represented within the scrolling region may precede a part of the text information represented within the edit region, may follow a part of the text information represented within the edit region, and/or the like. The relationship may depend, for example, upon the configuration of the electronic device and/or user input.

FIG. 1H is a diagram illustrating a text information representation 170 comprising an edit region 171, scrolling region 172, and scrolling region 173. Even though the example of FIG. 1H illustrates scrolling region 172 below edit region 171 and scrolling region 173 below edit region 171, the relative position of scrolling region 172, scrolling region 173, and edit region 171 does not limit the scope of the invention. In an example embodiment edit region 171, scrolling region 172, and/or scrolling region 173 may overlap. For example, scrolling region 172 and/or scrolling region 173 may overlay, cover, obscure, and/or the like, edit region 171. In the example of FIG. 1H, text information representation 170 may comprise information in addition to edit region 171 and scrolling region 172 similarly as described with reference to FIG. 1D. In addition to the relative positions of the scrolling region 172 and the edit region 171, the text information represented within the scrolling region and the edit region may have various relationships. For example, the text information represented within the scrolling region may precede the text information represented within the edit region, may follow the text information represented within the edit region, may overlap the text information represented within the edit region, and/or the like. The relationship may depend, for example, upon the configuration of the electronic device and/or user input.

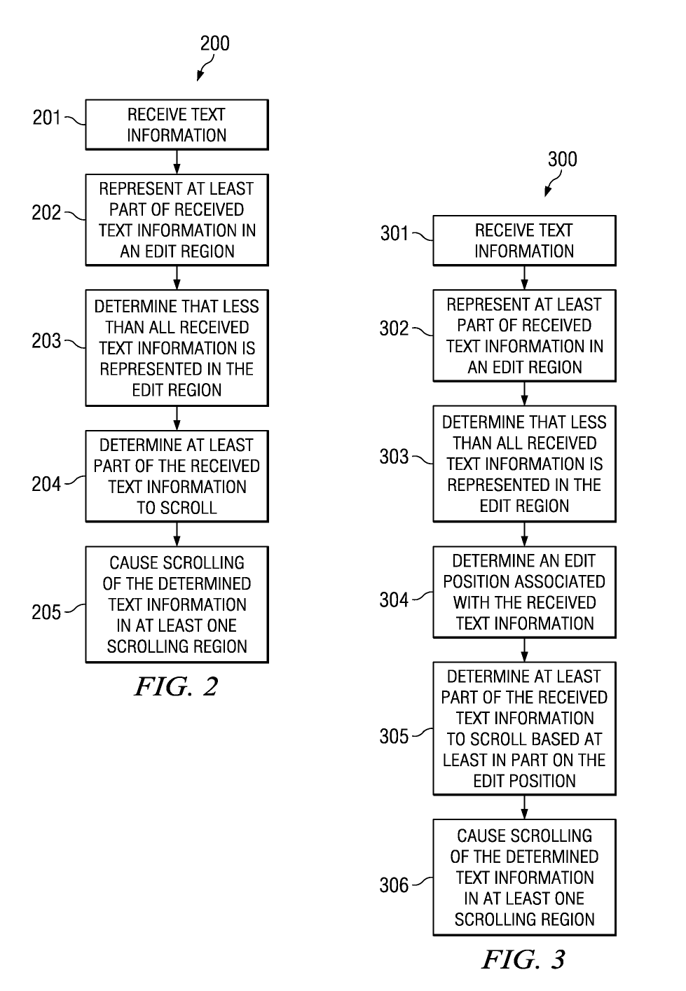

FIG. 2 is a flow diagram showing a set of operations 200 for representing text information. An apparatus, for example electronic device 10 of FIG. 5, may utilize the set of operations 200. The apparatus may comprise means, including, for example, the processor 20, for performing the operations of FIG. 2.

At block 201, the apparatus receives text information. The apparatus may receive the text information by retrieving the text information from one or more memories, such as non-volatile memory 42 of FIG. 5, receiving one or more indications of input, receiving text information from a receiver, such as receiver 16 of FIG. 5, and/or the like. For example, the apparatus may receive text information by receiving an indication of character input. In another example, the apparatus may receive text information by retrieving text information from a memory, such as volatile memory 40 of FIG. 5, and receiving an indication of character input.

At block 202, the apparatus represents at least part of the received text information in an edit region. The edit region may be similar to edit region 101 of FIG. 1A, edit region 161 of FIG. 1G, and/or the like. The apparatus may represent the entirety of the received text information in the edit region. Alternatively, the apparatus may represent a part of the received text in the edit region. For example, the received text information may comprise more text information than the apparatus may represent in the edit region. In an example embodiment, the apparatus may cause the representation of the edit region to be displayed, for example using display 28 of FIG. 5, an external display, a display on a different electronic device, and/or the like.

At block 203, the apparatus determines that less than all received text information is represented in the edit region. For example, the apparatus may compare the text information against the received text information, may utilize information associated with the operation of block 202, and/or the like, to determine that less than all received text information is represented in the edit region. In an example embodiment, the apparatus waits for the edit region to represent less than all received text information before proceeding to block 204.

At block 204, the apparatus determines at least part of the received text information to scroll. The apparatus may determine to scroll the entirety of the received text information or less than the entirety of the received text information. The apparatus may base the determination, at least in part, on the text information represented in the edit region. For example and in the context of the received text information, the apparatus may determine to scroll only received text information positioned before the text information represented in the edit region. In another example, the apparatus may determine to scroll only received text information positioned after the text information represented in the edit region. In still another example, the apparatus may determine to scroll only received text information not represented in the edit region.

At block 205, the apparatus causes scrolling of the determined text information in at least one scrolling region. The scrolling region may be similar to scrolling region 12 of FIG. 1B, scrolling region 142 of FIG. 1E, and/or the like. The scrolling region may be located separately from the edit region, such as described with reference to text representation 140 of FIG. 1E. The scrolling region may be overlapping the edit region such as described in text representation 162 of FIG. 1G. In an example embodiment, the scrolling region may overlap the entirety of the edit region. In such an embodiment, the edit region may be obscured by the scrolling region. The scrolling of the text information in the scrolling region may be automatic. For example, the scrolling may occur in a direction, speed, and/or the like according to a setting. The setting may be a predetermined setting, a user controlled setting, and/or the like. In an example embodiment, the apparatus automatically causes scrolling of determined text information in an upward vertical direction at a speed of I row per second. In another example embodiment, the apparatus automatically causes scrolling of determined text information in a leftward horizontal direction at a speed of 5 columns per second. In an example embodiment, the apparatus may cause the representation of the scrolling region to be displayed, for example using display 28 of FIG. 5, an external display, a display on a different electronic device, and/or the like.

In an example embodiment, the apparatus may repeat scrolling of the determined text information after completing the scrolling of the determined text information. For example, the apparatus may begin scrolling the determined text information again after scrolling to the end of the determined text information. In another example, the apparatus may scroll in an opposite direction after completing the scrolling. In such an example, after the apparatus scrolls the determined text information from beginning to end, the apparatus may scroll the determined text information from end to beginning. In such embodiments, the apparatus may vary scrolling repetition based, for example, upon the configuration of the electronic device and/or user input.

In an example embodiment, there may be more than one scrolling region, such as scrolling regions 122 and 123 of FIG. 1C, scrolling regions 172 and 173 of FIG. 1H, and/or the like. For example, a scrolling region may scroll received text information positioned, in the context of the received text information, before the text information represented in the edit region, and a different scrolling region may scroll received text information positioned, in the context of the received text information, after the text information represented in the edit region. In another example embodiment, the plurality of scrolling regions may provide for scrolling of different parts of the same determined text information. In such an embodiment scrolling regions may represent determined text information such that the scrolling regions represent differently located views of the same scrolling text information. For example, in an embodiment similar to text representation 170 of FIG. 1H, where edit region 171 represents one row of text information, the text information scrolled in scrolling region 172 may be represented to be positioned such that the lowest row of text information represented in scrolling region 172 is positioned two rows above the text information represented in the highest row of scrolling region 173. In such an example, the scrolling text information of scrolling regions 172 and 173 may appear to be scrolling behind edit region 171.

FIG. 3 is a flow diagram showing another set of operations 300 for representing text information. An apparatus, for example electronic device 10 of FIG. 5, may utilize the set of operations 300. The apparatus may comprise means, such as the processor 20, for performing the operations of FIG. 3.

At block 301, the apparatus receives text information. The operation of block 301 is similar as described with reference to block 201 of FIG. 2.

At block 302, the apparatus represents at least part of received text information in an edit region. The operation of block 302 is similar as described with reference to block 202 of FIG. 2.

At block 203, the apparatus determines that less than all received text information is represented in the edit region. The operation of block 303 is similar as described with reference to block 203 of FIG. 2.

At block 304, the apparatus determines an edit position associated with the received text information. In an example embodiment, the edit position relates to a position within the received text information. For example, the edit position may relate to a position preceding a beginning character in the received text information. In another example, the edit position may relate to a position between two adjacent characters in the received text information. In still another example, the edit position may relate to a position following a final character of the received text information. In yet another example, the edit position may relate to a position of a character in the received text information. The edit position may relate to a position in the text information representation of the edit region associated with a position where an input operation may modify the received text information. For example, the edit position may relate to a position in the edit region where an indication of input associated with a position selection was received. In such an example, the input may relate to a cursor movement, a touch on a touch display, a character input, and/or the like. In an example embodiment, the apparatus may determine the edit position to be the end of the received text information unless it received an indication of input related to a change in edit position.

At Block 305, the apparatus determines at least part of the received text information to scroll based at least in part on the edit position. The apparatus may determine to scroll less than the entirety of the received text information. For example, the determined text information may comprise text information before the edit position, after the edit position, and/or the like. In another example, the determined text information may comprises text information before the first character associated with a row corresponding to the edit position, text information after the last character associated with a row corresponding to the edit position, and/or the like. In still another example, determined text information may exclude text information associated with a row corresponding to the edit position.

At Block 306, the apparatus causes scrolling of the determined text information in at least one scrolling region. The operation of block 306 is similar as described with reference to block 205 of FIG. 2.

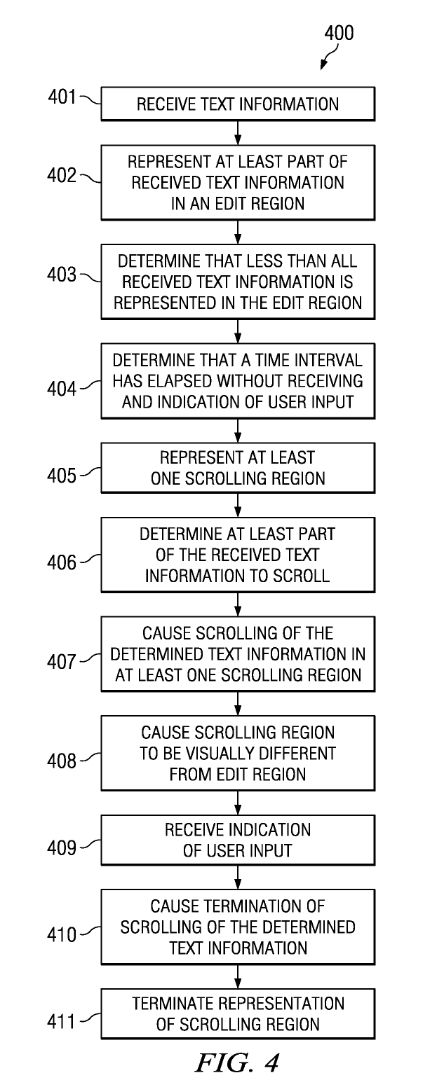

FIG. 4 is a flow diagram showing still another set of operations for representing text information. An apparatus, for example electronic device 10 of FIG. 5, may utilize the set of operations 400. The apparatus may comprise means, such as the processor 20, for performing the operations of FIG. 4.

At block 401, the apparatus receives text information. The operation of block 401 is similar as described with reference to block 201 of FIG. 2.

At block 402, the apparatus represents at least part of received text information in an edit region. The operation of block 402 is similar as described with reference to block 202 of FIG. 2.

At block 403, the apparatus determines that less than all received text information is represented in the edit region. The operation of block 403 is similar as described with reference to block 203 of FIG. 2.

At block 404, the apparatus determines that a time interval has elapsed without receiving an indication of a user input. The time interval may be predetermined and/or controlled by a setting. The setting may be configured by a user, network operator, apparatus manufacturer, and/or the like. User input may relate to keypad input, such as from keypad 30 of FIG. 5, touch display input, such as from display 28 of FIG. 5, and/or the like. In an example embodiment, the apparatus may wait for a time interval to elapse without receiving an indication of user input before proceeding to block 405. For example, the apparatus may wait for 2 seconds after the last indication of user input before proceeding to block 405.

At block 405, the apparatus represents at least one scrolling region. For example, the apparatus may introduce the representation of at least one scrolling region. In an example embodiment, representing one scrolling area may cause a text information representation without a scrolling region, such as text information representation 130 of FIG. 1D, to be represented comprising a scrolling region, such as text information representation 140 of FIG. 1E, text representation 160 of FIG. 1G, and/or the like. In an example embodiment, representing two scrolling areas may cause a text information representation without a scrolling region, such as text information representation 130 of FIG. 1D, to be represented comprising two scrolling regions, such as text information representation 170 of FIG. 1H. In an example embodiment the apparatus may cause the scrolling region to be displayed, for example using display 28 of FIG. 5, an external display, a display on a different electronic device, and/or the like.

At block 406, the apparatus determines an edit position associated with the received text information. The operation of block 406 is similar as described with reference to block 304 of FIG. 3.

At Block 407, the apparatus determines at least part of the received text information to scroll. The operation of block 406 is similar as described with reference to block 305 of FIG. 3 and/or 204 of FIG. 2.

At Block 408, the apparatus causes scrolling of the determined text information in at least one scrolling region. The operation of block 306 is similar as described with reference to block 205 of FIG. 2.

At block 409, the apparatus causes the scrolling region to be visually different from the edit region. The visual difference may relate to background, border, font, highlighting, color, illumination, and/or the like. In an example embodiment the apparatus may cause the visual difference to be displayed, for example using display 28 of FIG. 5, an external display, a display on a different electronic device, and/or the like.

At block 410 the apparatus receives indication of user input. User input may relate to keypad input, such as from keypad 30 of FIG. 5, touch display input, such as from display 28 of FIG. 5, and/or the like. For example, the apparatus may receive a character input. In an example embodiment, the apparatus waits until receiving an indication of a user input before proceeding to block 411. In an example embodiment, the user input is indicative of a desire to terminate scrolling. For example, the user input may relate to text information in the edit region, such as inputting an additional character, modifying a character, deleting a character, modifying an edit position, and/or the like.

At block 411, the apparatus causes termination of scrolling of the determined text information. The termination of scrolling may relate to stopping the scrolling on the determined text information, representing a different part of the determined text information within the scrolling region, and/or the like. For example, an apparatus may terminate scrolling by refraining from changing the text information representation of a scrolling region. In another example, the apparatus may terminate scrolling by displaying a different part of the determined text information and not scrolling the different part of the determined text information. In an example embodiment the apparatus may cause the text representation without scrolling to be displayed, for example using display 28 of FIG. 5, an external display, a display on a different electronic device, and/or the like.

At block 412, the apparatus terminates representation of at least one scrolling region. For example, the apparatus may remove the representation of at least one scrolling region. In an example embodiment, terminating one scrolling area may cause a text information representation comprising a scrolling region, such as text information representation 140 of FIG. 1E, text representation 160 of FIG. 1G, and/or the like, to be represented without a scrolling region, such as text information representation 130 of FIG. 1D. In an example embodiment, terminating two scrolling areas may cause a text information representation comprising two scrolling regions, such as text information representation 170 of FIG. 1H to be represented without a scrolling region, such as text information representation 130 of FIG. 1D. In an example embodiment the apparatus may cause the text representation without the scrolling region to be displayed, for example using display 28 of FIG. 5, an external display, a display on a different electronic device, and/or the like.

FIG. 5 is a block diagram showing an apparatus, such as an electronic device 10, according to an example embodiment of the invention. It should be understood, however, that an electronic device as illustrated and hereinafter described is merely illustrative of an electronic device that could benefit from embodiments of the invention and, therefore, should not be taken to limit the scope of the invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, global positioning system (GPS) devices and other types of electronic systems, may readily employ embodiments of the invention.

Furthermore, devices may readily employ embodiments of the invention regardless of their intent to provide mobility. In this regard, even though embodiments of the invention are described in conjunction with mobile communications applications, it should be understood that embodiments of the invention may be utilized in conjunction with a variety of other applications, both in the mobile communications industries and outside of the mobile communications industries.

The electronic device 10 may comprise an antenna 12 (or multiple antennae) in operable communication with a transmitter 14 and a receiver 16. The electronic device 10 may further comprise a processor 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

As used in this application, the term ‘circuitry’ refers to all of the following: hardware-only implementations (such as implementations in only analog and/or digital circuitry) and to combinations of circuits and software and/or firmware such as to a combination of processor(s) or portions of processor(s)/software including digital signal processor(s), software, and memory(ies) that work together to cause an apparatus, such as a mobile phone or server, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor, multiple processors, or portion of a processor and its (or their) accompanying software and/or firmware. The term “circuitry” would also cover, for example, a baseband integrated circuit or applications processor integrated circuit for a mobile phone or a similar integrated circuit in a cellular network device or other network device.

Processor 20 may comprise means, such as circuitry for implementing audio, video, communication, navigation, logic functions, and or the like, as well as for implementing embodiments of the invention including, for example, one or more of the functions described in conjunction with FIGS. 1-4. For example, processor 20 may comprise means, such as a digital signal processor device, a microprocessor device, various analog to digital converters, digital to analog converters, processing circuitry and other support circuits, for performing various functions including, for example, one or more of the functions described in conjunction with FIGS. 1-4. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment of the invention including, for example, one or more of the functions described in conjunction with FIGS. 2-4. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display may determine input based on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise a memory device including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 14. For example, the memories may comprise an identifier, such as an international mobile equipment identification (IMEI) code, which may uniquely identify the electronic device 10.

Although FIG. 5 illustrates an example of an electronic device that may utilize embodiments of the invention including those described and depicted, for example, in FIGS. 1-4, electronic device 10 of FIG. 5 is merely an example of a device that may utilize embodiments of the invention.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any media or means that can contain, or store the instructions for use by or in connection with an instruction execution system, apparatus, or device, such as a computer, with one example of a computer described and depicted in FIG. 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the invention as defined in the appended claims.

1. An apparatus comprising:
a processor;
memory including computer program code, the memory and the computer program code configured to, working with the processor, cause the apparatus to perform at least the following:
provide for receiving text information;
provide for representation of at least part of received text information in an edit region;
determine that less than all received text information is represented in said edit region;
determine at least part of said received text information to scroll; and
cause scrolling of said determined text information in at least one scrolling region.

2. The apparatus of claim 1, wherein said processor is further configured to represent said at least one scrolling region based at least in part on a determination that less than all received text information is represented in said edit region.

3. The apparatus of any of claim 1, wherein said processor is further configured to determine an edit position associated with said received text information and determine at least part of said received text information to scroll based at least in part on said edit position.

4. The apparatus of claim 3, wherein said edit position relates to a position selection.

5. The apparatus of claim 3, wherein said edit position relates to a position associated with text corresponding to received text input.

6. The apparatus of claim 3, wherein said edit position relates to a position associated with an end of the received text information.

7. The apparatus of claim 3, wherein said determined text information comprises text information before said edit position.

8. The apparatus of claim 3, wherein said determined text information comprises text information after said edit position.

9. The apparatus of claim 3, wherein said determined text information comprises text information before a first character associated with a row corresponding to said edit position.

10. The apparatus of claim 3, wherein said determined text information comprises text information after a last character associated with a row corresponding to said edit position.

11. The apparatus of claim 3, wherein said determined text information excludes text information associated with a row corresponding to said edit position.

12. The apparatus of claim 3, wherein said scrolling region overlaps with at least one part of said edit region, wherein said edit region does not include a row corresponding to said edit position.

13. The apparatus of claim 1, wherein said edit region comprises a plurality of rows of text.

14-79. (canceled)

80. The apparatus of claim 1, wherein said processor is further configured to determine that a time interval has elapsed without receiving indication of user input.

81. The apparatus of claim 1, wherein said scrolling region and said edit region at least partially overlap.

82. The apparatus of claim 1, wherein said processor is further configured to cause said scrolling region to be visually different from said edit region.

83. The apparatus of claim 1, wherein said processor is further configured to:
provide for receiving an indication of user input; and
cause termination of scrolling of said determined text information based at least in part on said input.

84. The apparatus of claim 1, wherein said processor is further configured to:
provide for receiving an indication of user input; and
cause termination of representation of scrolling region based at least in part on said input.

85. The apparatus of claim 1, wherein said processor is further configured to cause display of said scrolling region.

86. The apparatus of claim 1, wherein said processor is further configured to cause display of said edit region.

87. The apparatus of claim 1, wherein said apparatus is a mobile device.

88. The apparatus of claim 1, wherein said apparatus is a mobile device.

89. A method, comprising:
receiving text information;
representing at least part of received text information in an edit region;
determining that less than all received text information is represented in said edit region;
determining at least part of said received text information to scroll; and
causing scrolling of said determined text information in at least one scrolling region.

90. A computer-readable medium encoded with instructions that, when executed by a computer, perform:
providing for receiving text information;
providing for representing at least part of received text information in an edit region;
determining that less than all received text information is represented in said edit region;
determining at least part of said received text information to scroll; and
causing scrolling of said determined text information in at least one scrolling region.

91. A computer program product comprising a computer-readable medium bearing computer program code embodied therein for use with a computer, the computer program code comprising:
code for providing for receiving text information;
code for providing for representing at least part of received text information in an edit region;
code for determining that less than all received text information is represented in said edit region;
code for determining at least part of said received text information to scroll; and
code for causing scrolling of said determined text information in at least one scrolling region.
